(19) United States
(12) Patent Application Publication
(10) Pub. No.: US 2007/0244717 A1
(43) Pub. Date: Oct. 18, 2007

(54) METHODS AND APPARATUS FOR COLLECTING DATA RELATING TO MEDICAL SCIENCE COMPLIANCE

(76) Inventors: Neil Baptista, New York, NY (US); Josh Wolf, New York, NY (US); John Corcoran, Essex, MA (US); Michael Taylor, New York, NY (US)

Correspondence Address: CHOATE, HALL & STEWART LLP, TWO INTERNATIONAL PLACE, BOSTON, MA, 02110, US

(21) Appl. No.: 11/279,525

(22) Filed: Apr. 12, 2006

(51) Int. Cl. G06Q 10/00; G06F 3/048

(52) U.S. Cl. 705/2; 715/764

(57) ABSTRACT

The present invention is directed towards improving compliance systems and methodologies for medical science liaisons. In one aspect, the present invention is a method for collection of data relating to compliance issues of medical science liaisons. The method may comprise displaying a first input screen, said screen comprising fields which accept the input of messages and categories for said messages, wherein said categories are limited to a predetermined number of subjects relating to job functions of a medical science liaison; displaying a second input screen, said screen comprising fields which accept input of profile data; displaying a third input screen, said screen comprising fields which accept input of activity data; storing said message data, said profile data, and said activity data; and displaying an output screen comprising a series of said data, said series of data corresponding to a given compliance issue.

### FIELD OF THE INVENTION

The present invention is directed towards improving analysis methodologies and systems for medical science liaisons.

### BACKGROUND OF THE INVENTION

Medical science liaisons (MSLs) are known to the health care industry as personnel who act as liaisons between health product manufacturers and health care service providers. MSLs may be employed by any company in the health care industry, including without limitation pharmaceutical companies and medical device manufacturers. MSLs may also be referred to as science liaisons, science representatives, medical liaisons and other similar terms. MSLs frequently have degrees in medicine, pharmacy, or science and typically provide a science-oriented point of contact the health care companies they are employed by, and the doctors the company is seeking to reach. Activities of MSLs may include proposing and facilitating studies and trials of particular treatments, and helping doctors obtain research grants and funding. Other activities may include attending science and medical conferences to discuss research and particular treatments with health care providers. Still other activities may include visiting hospitals to inquire about the success, failure, or likelihood of adopting a given treatment. Still other activities may include supporting education programs, such as providing seminars, classes, and research for doctors.

An MSL may interact with a number of health care professionals and institutions. An MSL may interact with personnel including doctors, nurses, medical students, medical researchers, professors, and hospital administrators. An MSL may interact with institutions including hospitals, private practices, clinics, medical schools, and research centers. Companies may rely on medical science liaisons to promote awareness and use of a given treatment among medical professionals and institutions. However, a number laws, regulations, and guidelines apply to activities of MSLs and the products and treatments associated with MSLs. There thus exists a need for means of the collecting and displaying data relating to MSL compliance with the above regulations.

### SUMMARY OF THE INVENTION

The present invention is directed towards improving compliance systems and methodologies for medical science liaisons.

In one aspect, the present invention is a method for collection of data relating to compliance issues of medical science liaisons. The method may comprise displaying a first input screen, said screen comprising fields which accept the input of messages and categories for said messages, wherein said categories are limited to a predetermined number of subjects relating to job functions of a medical science liaison; displaying a second input screen, said screen comprising fields which accept input of profile data; displaying a third input screen, said screen comprising fields which accept input of activity data; storing said message data, said profile data, and said activity data; and displaying an output screen comprising a series of said data, said series of data corresponding to a given compliance issue.

In another aspect, the present invention is a computer system for collection of data relating to compliance issues of medical science liaisons. The computer system may comprise a first input screen comprising fields which accept the input of messages and categories for said messages; a second input screen comprising fields which accept input of profile data; a third input screen comprising fields which accept input of activity data; a storage element storing said message data, profile data, and activity data; and a display screen comprising a series of said messages, said series comprising a number of messages corresponding to a given category.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIGS. 1A and 1B are block diagrams of embodiments of a computing or network device;

FIG. 2 is a block diagram illustrating an embodiment of a client-server network;

FIG. 3 is a block diagram of an example input screen for collection of message data relating to medical science liaisons;

FIG. 4 is a block diagram of an example of an input screen for collection of activity data relating to medical science liaisons;

FIG. 5A is a block diagram of an example of an input screen for collection of profile data relating to medical professionals;

FIG. 5B is another block diagram of an example of an input screen for collection of profile data relating to medical professionals;

FIG. 6 is a block diagram of an example input screen for collection of hospital data;

FIG. 7A is a block diagram of an example of an output screen for display of message data relating to medical science liaisons;

FIG. 7B is a block diagram of an example of an output screen for display of profile data corresponding to medical professionals;

FIG. 7C is a block diagram of an example of an output screen for display of activity data relating to medical science liaisons;

FIG. 8 is a block diagram of an first example output screen comprising a time-based visual depiction of data corresponding to the results of activities of medical science liaisons;

FIG. 9 is a block diagram of a second example output screen comprising a time-based visual depiction of data corresponding to the results of activities of medical science liaisons;

FIG. 10 is a block diagram of a medical science liaison information center;

FIG. 10B is a block diagram of an example home page for a user of a medical science liaison information center;

FIG. 11 is a flow diagram depicting one embodiment of a method for collection of data relating to medical science liaisons;

FIG. 12 is a flow diagram depicting one embodiment of a method for collection of data relating to compliance issues of medical science liaisons; and

FIG. 13 is a flow diagram depicting one embodiment of a method for collection and analysis of data relating to medical science liaisons.

### DETAILED DESCRIPTION OF THE INVENTION

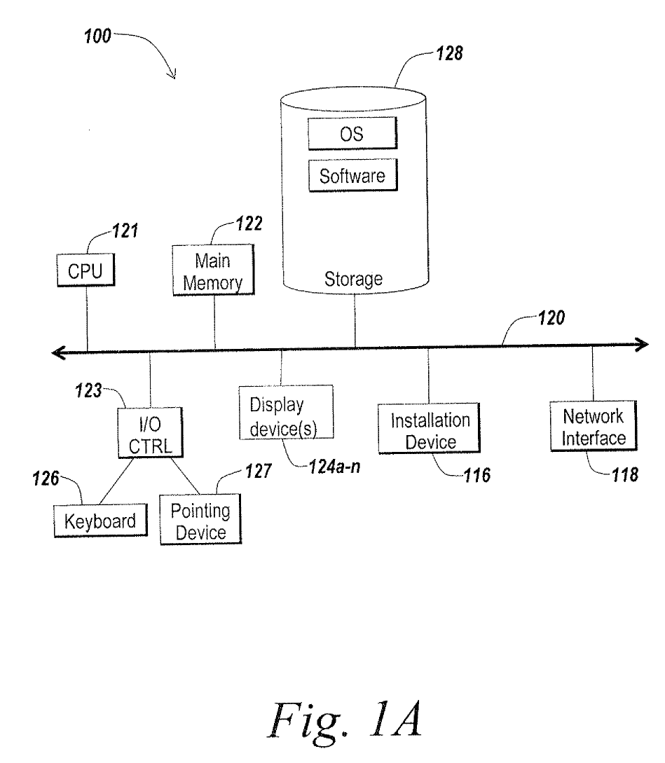

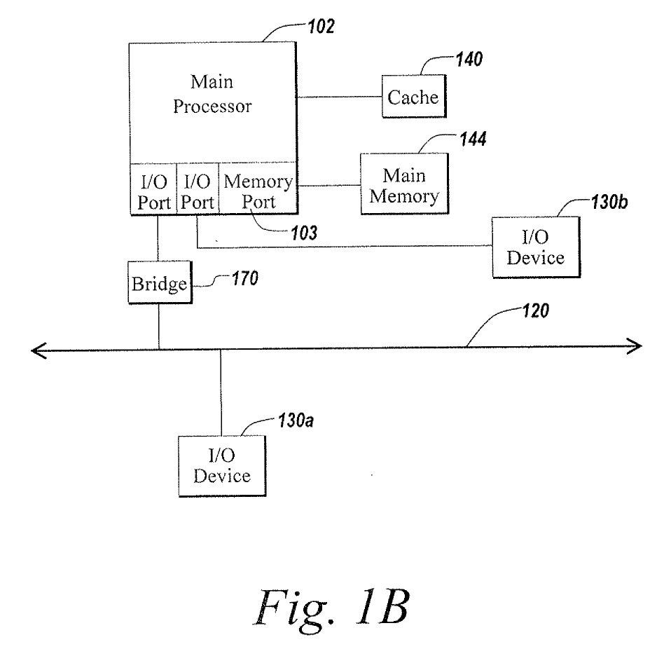

Referring now to FIGS. 1A and 1B block diagrams of a typical computer 100 useful as client computing devices and server computing devices are shown. As shown in FIGS. 1A and 1B, each computer 100 includes a central processing unit 102, and a main memory unit 104. Each computer 100 may also include other optional elements, such as one or more input/output devices 130a-130-b (generally referred to using reference numeral 130), and a cache memory 140 in communication with the central processing unit 102.

The central processing unit 102 is any logic circuitry that responds to and processes instructions fetched from the main memory unit 104. In many embodiments, the central processing unit is provided by a microprocessor unit, such as those manufactured by Intel Corporation of Mountain View, Calif.; those manufactured by Motorola Corporation of Schaumburg, Ill.; the Crusoe and Efficeon lines of processors manufactured by Transmeta Corporation of Santa Clara, Calif.; the lines of processors manufactured by International Business Machines of White Plains, N.Y.; or the lines of processors manufactured by Advanced Micro Devices of Sunnyvale, Calif.

Main memory unit 104 may be one or more memory chips capable of storing data and allowing any storage location to be directly accessed by the microprocessor 102, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). In the embodiment shown in FIG. 1A, the processor 102 communicates with main memory 104 via a system bus 120 (described in more detail below). FIG. 1B depicts an embodiment of a computer system 100 in which the processor communicates directly with main memory 104 via a memory port. For example, in FIG. 1B the main memory 104 may be DRDRAM.

FIGS. 1A and 1B depict embodiments in which the main processor 102 communicates directly with cache memory 140 via a secondary bus, sometimes referred to as a “backside” bus. In other embodiments, the main processor 102 communicates with cache memory 140 using the system bus 120. Cache memory 140 typically has a faster response time than main memory 104 and is typically provided by SRAM, BSRAM, or EDRAM.

In the embodiment shown in FIG. 1A, the processor 102 communicates with various I/O devices 130 via a local system bus 120. Various busses may be used to connect the central processing unit 102 to the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is an video display, the processor 102 may use an Advanced Graphics Port (AGP) to communicate with the display. FIG. 1B depicts an embodiment of a computer system 100 in which the main processor 102 communicates directly with I/O device 130b via HyperTransport, Rapid I/O, or InfiniBand. FIG. 1B also depicts an embodiment in which local busses and direct communication are mixed: the processor 102 communicates with I/O device 130a using a local interconnect bus while communicating with I/O device 130b directly.

A wide variety of I/O devices 130 may be present in the computer system 100. Input devices include keyboards, mice, trackpads, trackballs, microphones, and drawing tablets. Output devices include video displays, speakers, inkjet printers, laser printers, and dye-sublimation printers. An I/O device may also provide mass storage for the computer system 800 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In further embodiments, an I/O device 130 may be a bridge between the system bus 120 and an external communication bus, such as a USB bus, an Apple Desktop Bus, an RS-132 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose computers of the sort depicted in FIG. 1A and FIG. 1B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

For embodiments comprising mobile devices, the device may be a JAVA-enabled cellular telephone, such as the i55sr, i58sr, i85s, or the i88s, all of which are manufactured by Motorola Corp. of Schaumburg, Ill.; the 6035 or the 7135, manufactured by Kyocera of Kyoto, Japan; or the i300 or i330, manufactured by Samsung Electronics Co., Ltd., of Seoul, Korea. In other embodiments comprising mobile devices, a mobile device may be a personal digital assistant (PDA) operating under control of the PalmOS operating system, such as the Tungsten W, the VII, the VIIx, the i705, all of which are manufactured by palmOne, Inc. of Milpitas, California. In further embodiments, the client 113 may be a personal digital assistant (PDA) operating under control of the PocketPC operating system, such as the iPAQ 4155, iPAQ 5555, iPAQ 1945, iPAQ 2215, and iPAQ 4255, all of which manufactured by Hewlett-Packard Corporation of Palo Alto, Calif.; the ViewSonic V36, manufactured by ViewSonic of Walnut, California; or the Toshiba PocketPC e405, manufactured by Toshiba America, Inc. of New York, N.Y. In still other embodiments, the mobile device is a combination PDA/telephone device such as the Treo 180, Treo 270, Treo 600, Treo 650, or the Treo 700, all of which are manufactured by palmOne, Inc. of Milpitas, Calif. In still further embodiments, the mobile device is a cellular telephone that operates under control of the PocketPC operating system, such as the MPx200, manufactured by Motorola Corp. A typical mobile device may comprise many of the elements described above in FIGS. 1A and 1B, including the processor 102 and the main memory 104.

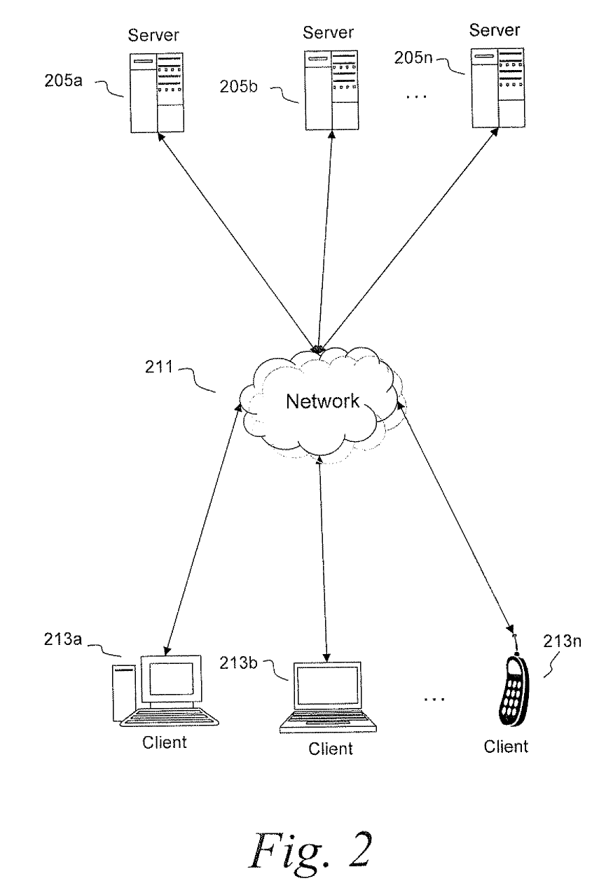

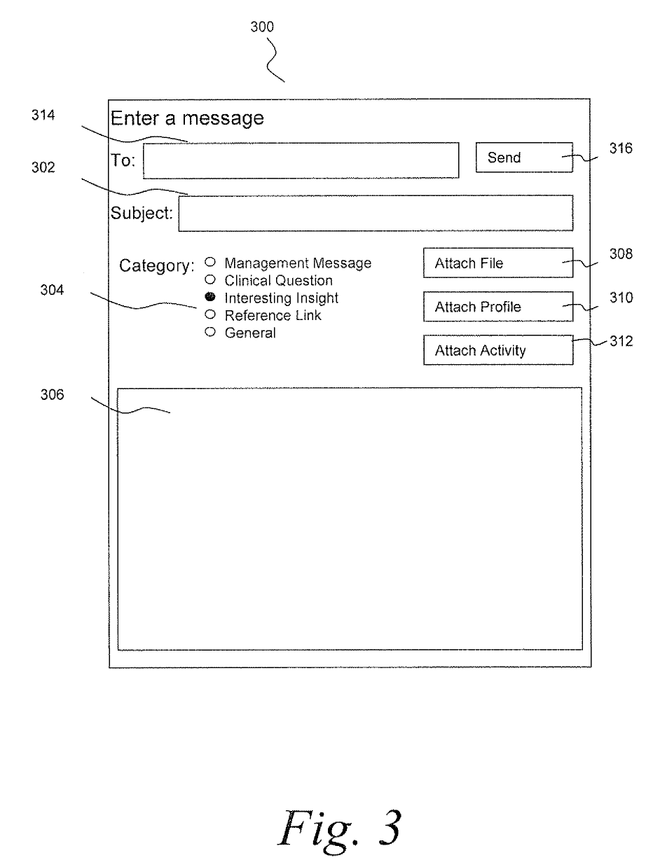

FIG. 2 depicts a block diagram illustrating an embodiment of a client-server network. In brief overview, a number of clients 213a, 213b, . . . 213n′ (collectively referred to as 213), are connected via a network 211 to a number of servers 205a, 205b, 205n (collectively referred to as 205). The clients 213, networks 211, and servers 205 may comprise any computing devices comprising substantially similar capabilities, descriptions, functions, and configurations as described above.

Still referring to FIG. 2, in greater detail, a number of servers 205 is shown. In the embodiment shown, the servers 205 may comprise any device capable of processing information and sending and receiving information, including a standalone computer server, a blade server, a rack mounted server, or a group of any types of said servers. The servers may further comprise databases, file servers, web servers, application servers or any other type of server. In embodiments involving multiple servers, the servers may be identical servers, or may differ in make, model type, content, performance, availability, or any other aspect.

The network 211 may comprise the Internet, local networks, web servers, file servers, routers, databases, computers, servers, network appliances, or any other computing devices capable of sending and receiving information. The network 211 may comprise computing devices connected via cables, IR ports, wireless signals, or any other means of connecting multiple computing devices. The network 211 and any devices connected to the networks may communicate via any communication protocol used to communicate among or within computing devices, including without limitation SSL, HTML, XML, RDP, ICA, FTP, HTTP, TCP, IP, UDP, IPX, SPX, NetBIOS, NetBEUI, SMB, SMTP, Ethernet, ARCNET, Fiber Distributed Data Interface (FDDI), RS232, IEEE 802.11, IEEE 802.11a, IEE 802.11b, IEEE 802.11g and direct asynchronous connections, or any combination thereof. The networks 211 may comprise mobile telephone networks utilizing any protocol or protocols used to communicate among mobile devices including AMPS, TDMA, CDMA, GSM, GPRS or UMTS.

Referring now to FIGS. 3, 4, 5A, 5B, and 6, diagrams depicting example input screens for input of data corresponding to MSLs are shown. An input screen may be displayed on any display device of any of the computing devices 100 described herein. In some embodiments, an input screen may be displayed on a computer monitor. In another embodiment, an input screen may be displayed as an application. In one embodiment, an input screen may be displayed inside a web browser. An input screen may comprise any display, scripting, or programming language including HTML, XML, SVG, Java, Javascript, and Flash.

The input screens depicted may comprise a number of fields. Said fields may comprise any means for accepting input, including text boxes, text fields, password fields, check boxes, radio buttons, buttons, dials, toggles, sliders, scroll bars, lists, and menus. Any and all of said fields may comprise functionality for auto-completion. Any and all of said fields may comprise default values and presets. In some embodiments, the input screens may utilize a scripting language, such as Javascript, to provide functionality associated with filling in, storing, or displaying data.

Referring now to FIG. 3, a block diagram of an example input screen for collection of data relating to MSLs is shown. In brief overview, an input screen 300 may comprise a fields for entering a message subject 302, a message category 304, and a message body 306. The input screen 300 may also comprise inputs for linking a file 310, linking a profile 312, or linking an activity 314.

Still referring to FIG. 3, now in greater detail, an input screen 300 for collection of message data relating to MSLs is shown. An input screen 300 may comprise a field for entering a message subject 302. In some embodiments, the field 302 comprises a text field for entering text corresponding to a message subject. In some embodiments, the field may be pre-completed. For example, if the input screen 300 is displayed in response to a user request to reply to a given message, the subject may be pre-completed with “RE:” and the subject of the previous message. Or, for example, if the input screen 300 is displayed in response to a user request to ask for information concerning a given activity, the subject may be pre-completed with the title of the given activity.

An input screen 300 may comprise a field for entering a message category, wherein said categories are limited to a predetermined number of subjects 304. The field 304 may comprise any input means for specifying one of a predetermined number of subjects, including a menu, checkbox, button, radio button, or text field. In some embodiments, the predetermined number of subjects may comprise subjects corresponding to activities of MSLs. Said subjects may comprise any subjects corresponding to activities of MSLs, including clinical activities, doctor contacts, questions, and research. In some embodiments, an input screen 300 may refuse to accept input of a message if a message category is not specified. In other embodiments, an input screen 300 may comprise a default message category.

An input screen 300 may comprise a field for entering a message body 306. A message body may comprise plain text, formatted text, images, or files. In some embodiments the input screen 300 may comprise separate fields for including formatted text, images, or files in a message body.

An input screen 300 may comprise additional fields for linking files 308, profiles 310, or activities 312. In some embodiments, the fields may comprise text fields for the entry of a file, profile, or activity name. In other embodiments, the fields may comprise buttons, which when pressed display a menu or list of files, profiles, or activities. In still other embodiments, the fields may comprise pull-down menus listing recently viewed or entered files, profiles, or activities. In one embodiment, linking a file, profile, or activity to a message may comprise attaching a copy of said file, profile, or activity to the given message. In another embodiment, linking a file, profile, or activity to a message may comprise including in a link to said file, profile, or activity the given message. In still another embodiment, linking a file, profile, or activity to a message may comprise including said file, profile, or activity within said message.

In some embodiments, a field for linking a file 308 may comprise a field which allows users to link a specific version of a given file. In one embodiment, the field 308 may comprise a checkbox which allows a user to specify whether to preserve the version of the file. For example, a user may wish to send a current version of company policies with respect to MSLs, and wish to ensure that a person later viewing the message receives the version the user referred to, rather than an earlier or later version. In this example, the field 308 may comprise means for specifying that the current version of the policies should be stored alongside said message. In some embodiments, after specifying a given version of a document, the given version may be stored in a database or file server for later access. Examples of files that may be linked include, without limitation, documents, spreadsheets, slide presentations, articles, and web pages.

In some embodiments the fields 308, 310, 312 may be pre-completed to automatically link to a given file, profile, or activity. In one embodiment, a field may comprise an automatic link to a profile of the user creating the message. In another embodiment, a field may comprise an automatic link to an activity the user creating the message recently completed. In still another embodiment, a field may comprise an automatic link to a profile, activity, or file that the user creating the message recently viewed. In some embodiments, a field may comprise a checkbox or other means of specifying whether an automatically linked or attached item should be included with a given message.

The input screen 300 may also comprise any other fields or functionality known to messaging or e-mail programs, including but not limited to specifying one or multiple recipients 314, submit buttons 316, spell-checking functionality, conversation views, and address books. In some embodiments, the input screen may comprise a field for marking a given message as urgent or otherwise indicating priority. In some embodiments the input screen may be customized to a given user. In other embodiments, the input screen may be generic across a number of users.

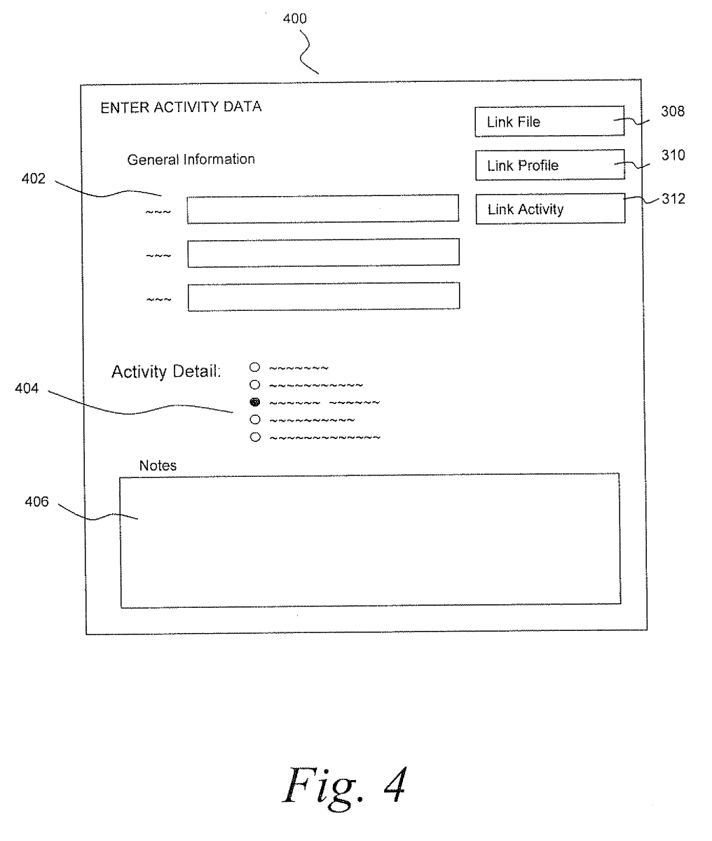

Referring now to FIG. 4, a block diagram of an example of an input screen for collection of activity data relating to MSLs is shown. In the example shown, the input screen 4 may comprise fields for entering general information about the activity 402, fields for specifying activity detail 404, and fields for entering notes 406. The input screen 400 may also comprise inputs for linking a file 308, linking a profile 310, or linking an activity 312, as previously described.

Still referring to FIG. 4, now in greater detail, an input screen 400 comprises a variety of fields for the input of activity data. Said activity data may correspond to any activity undertaken by a MSL in the performance of his or her job, including research, interaction with medical professionals, interaction with medical institutions, conferences, corporate communication, and communication with other MSLs. Examples of specific activities may include visiting a doctor to confer about a potential treatment's effectiveness, or to discuss inclusion of a drug or device in a given clinical trial. The input screen 400 may accept any information relating to an activity.

The input screen 400 comprises fields for entering general information corresponding to an activity. Said general information may comprise a time, date, place, and description of a given activity. Said general information may also comprise detail about a given person corresponding to said activity. For example, if an activity consists of meeting a doctor at a given conference, the general information may comprise the name, date, and location of the conference, and the name and title of the doctor. In some embodiments, the general information may comprise a field for specifying whether a given activity has been completed.

The input screen 404 may also comprise fields for specifying an activity detail 404. The activity detail may comprise a categorization of a given activity. For example, a given set of options for specifying an activity detail may comprise “administration,” “research,” “follow-up,” “travel,” and “other.” In some embodiments, a list of options for specifying an activity detail may be modified in response to general information about an event. For example, for an event corresponding to a hospital, the list of options may comprise “Clinical Topic Discussions,” “Educational Needs Assessment,” “Research: trial inquiry,” and “Institutional Profiling.”

The input screen 400 may also comprise fields for entering notes 406 corresponding to a given activity. Notes may comprise plain text, formatted text, images, or files. In some embodiments the input screen 300 may comprise separate fields for including formatted text, images, or files in notes.

In some embodiments, specialized input screens 400 may be created for a given activity. For example, a menu might prompt a user to specify whether an activity corresponds to a particular hospital or medical institution. If an activity corresponds to a hospital, an input screen 400 may be displayed with input fields corresponding to a particular hospital. In some embodiments, a field might be displayed with a list of contacts known at a given hospital, and a user may be able to select a subset of the contacts as involved in the given activity. In other embodiments, in response to a user specifying that an activity takes place at a hospital, an input screen 400 may comprise specific activity detail options known to a particular hospital. For example, an input screen 400 may comprise activity detail fields 404 such as “follow-up regarding Children's Hospital research trial.”

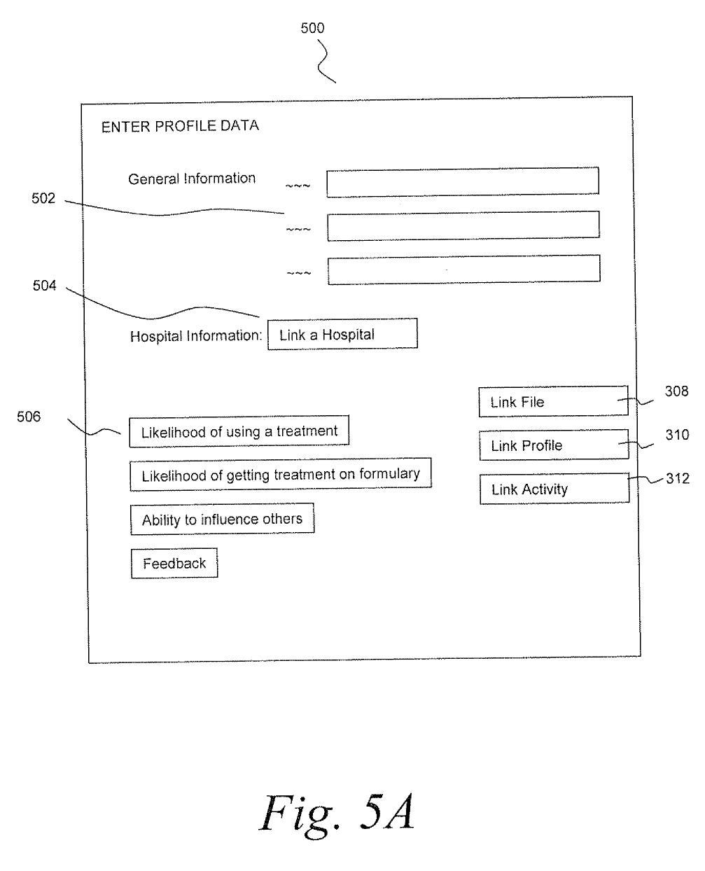

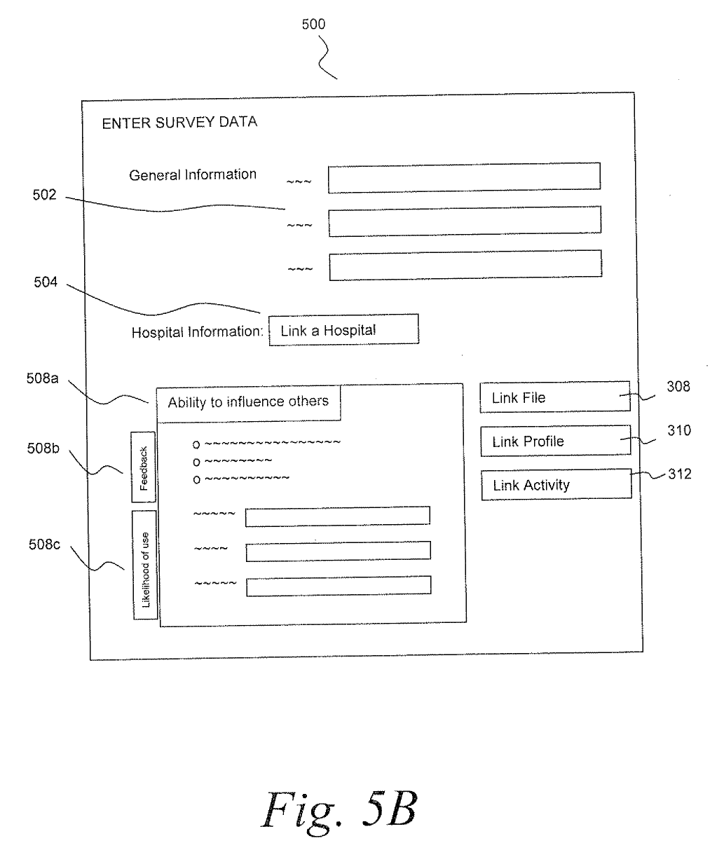

Referring now to FIG. 5A, a block diagram of an example of an input screen for collection of profile data relating to medical professionals is shown. In brief overview, an input screen 500 comprises fields for entering general information corresponding to a medical professional 502, a field for linking to a hospital 504, fields for entering specific data corresponding to MSL interactions 506, and fields for linking a file 308, linking a profile 310, or linking an activity 312, as previously described. Medical professionals may include any persons employed in the medical profession, including MSLs, doctors, nurses, nurse practitioners, pharmacists, medical students, medical researchers, professors, and hospital administrators.

Still referring to FIG. 5A, now in greater detail, an input screen 500 may comprise fields for entering general information corresponding to a medical professional's profile 502. Said general information may comprise any biographical data, including name, age, gender, occupation, employer, educational background, research background, and clientele. Said general information may also comprise any contact information, including addresses, email addresses, and phone numbers.

An input screen 500 may also comprise fields 504 for linking a given medical professional to a hospital or medical institution. For example, if a profile corresponds to a doctor who worked at a number of hospitals, the doctor's profile may be linked to each of the hospitals. The field 504 may link information corresponding to a hospital in any manner similar to the methods previously described herein for the fields linking files 308, profiles 310, and activities 312.

An input screen 500 may also comprise fields for entering specific data corresponding to MSL interactions 506. Said specific data may comprise information corresponding to past contacts with a given MSL, and likelihood of future activity with respect to a MSL or any services or products related to a MSL. For example, a field 506 may comprise a radio button corresponding to the likelihood of a doctor adopting a treatment course proposed by a given MSL. Or, for example, a field 506 may comprise a radio button for input of a MSL's opinion on how influential a given medical professional is. Or, for example, a field 506 may comprise a text field for input of feedback a doctor has provided to a given MSL.

Referring now to FIG. 5B, a block diagram of another example of an input screen for collection of profile data relating to medical professionals is shown. In brief overview, an input screen 500 comprises fields for entering general information corresponding to a medical professional 502, a field for linking to a hospital 504, and fields for linking a file 308, linking a profile 310, or linking an activity 312, as previously described. The input screen also comprises a number of tabs 508a, 508b, and 508c (generally referred to as 508) corresponding to surveys for collection of information relating to the profile.

Still referring to FIG. 5B, now in greater detail, a profile input screen 500 may comprise a number of tabs corresponding to surveys relating to a medical professional. Clicking on a given tab 508 may then display a survey related to the medical professional. Surveys may comprise any group of questions or information corresponding to the medical professional. In the embodiment shown, the surveys correspond to “ability to influence others,” “feedback,” and “likelihood of use.” In other embodiments, surveys may correspond to educational efforts aimed at doctors, efforts to assist doctor research, sales team education, doctor satisfaction with MSLs, and forecasts of future activity or sales.

The surveys may accept data using any of the techniques and fields described herein. In one embodiment, survey may comprise functionality for partial completion. For example, an MSL who was filling out a survey relating to a given doctors likelihood of adopting a particular treatment may complete half of the questions at a given time, log off and then return to the input screen at a later time to complete the survey.

In some embodiments, a survey may be used to determine the relative influence of a medical professional. For example, an MSL may have an interest in identifying doctors who strongly influence the practices of other doctors. These doctors may be known or referred to as thought leaders, opinion leaders, or key opinion leaders. A survey to identify an opinion leader may include any questions to identify the scope of a doctor's influence, including questions related to the number of doctors who follow a given physician's practice, questions related to influential publications of the doctor, and questions related to the doctor's experience in a given area.

In other embodiments, surveys may be accessed by input means other than tabs. Surveys may be accessed using any of the fields described herein, including pull-down menus, buttons, and text fields. For example, a profile may be displayed with a pull-down menu labeled “Surveys” comprising the surveys applicable to the given profile. In some embodiments, a global list of available surveys may also be provided in profile input screen 500 along with means for a user to indicate that a given survey is applicable to the profile.

In some embodiments, answers to a given survey may change over time. In one embodiment, a survey may provide functionality for tracking answers over a given time period. For example, a question might in a survey relating to product use might ask how many times a given doctor has prescribed a given product in the last month. Each month, the answer to the survey question may change, and the survey may comprise functionality for storing and displaying a series of responses to the question. Other examples of questions with answers changing over time may be questions related to doctor satisfaction, and educational level of contacts. In some embodiments, all the answers to a given survey may change over time, in other embodiments only some of the answers to a given survey may change over time.

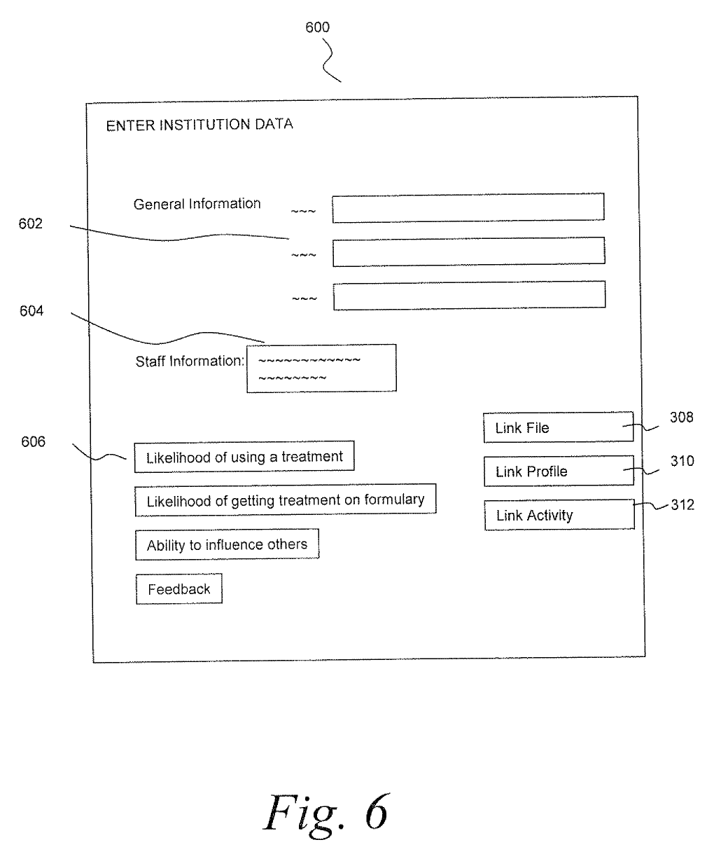

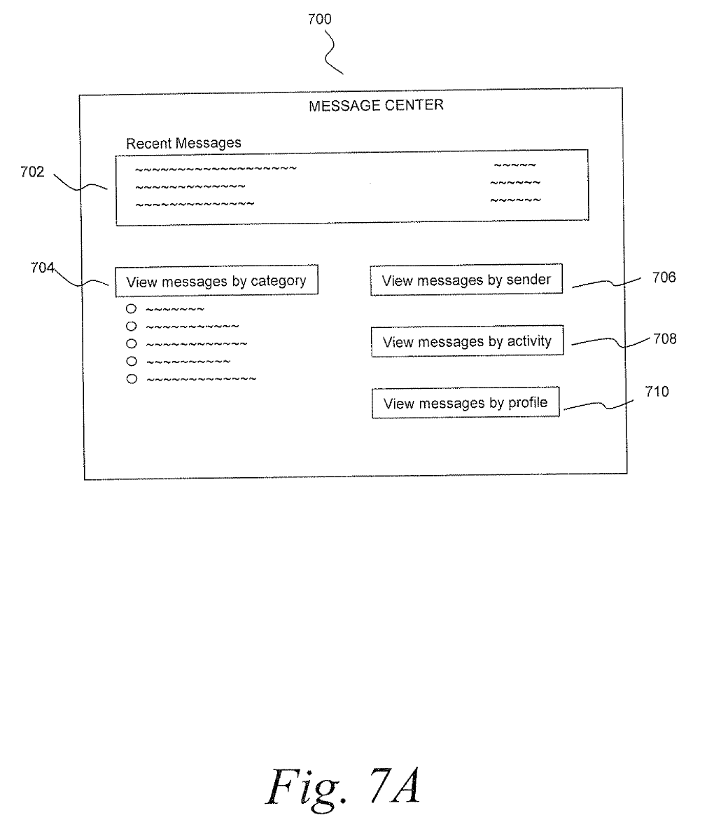

Referring now to FIG. 6, a block diagram of an example input screen for collection of medical institution data is shown. In brief overview, an input screen 600 comprises fields for the input of general information 602, staff information 604; other information 606, and fields for linking a file 308, linking a profile 310, or linking an activity 312, as previously described.

Still referring to FIG. 6, now in greater detail, an example input screen 600 for collection of medical institution data is shown. A medical institution may comprise any building, facility, campus, corporation, organization, or group of organizations engaged in medical practice, study, funding, or research. Examples of medical institutions may comprise hospitals, clinics, HMOs, insurance companies, universities, medical schools, medical associations, and journals.

An input screen 600 may comprise fields for entry of general information 602 corresponding to said medical institution. General information may comprise any information relating to the institution, including the institution type, name, location, address, affiliations, and background.

An input screen 600 may comprise fields for entry of staff information 604 relating to a medical institution. Staff information may comprise information, including names, contact information, titles, and backgrounds, of any employees and affiliates of a medical institution. Examples of staff may include doctors, nurses, professors, students, secretaries, receptionists, research coordinators, and pharmacists.

An input screen may also comprise fields for entry of information corresponding to specific MSL interactions 606. Said specific data may comprise information corresponding to past contacts with a given MSL, and likelihood of future activity with respect to a MSL or any services or products related to a MSL. For example, a field 506 may comprise a radio button corresponding to the likelihood of a hospital adopting a treatment course proposed by a given MSL. Or, for example, a field 506 may comprise a radio button for input of a MSL's opinion on how influential a given medical institution is. Or, for example, a field 506 may comprise a text field for input of feedback a hospital has provided to a given MSL. In still other embodiments, an input screen 600 may comprise one or more surveys as described herein.

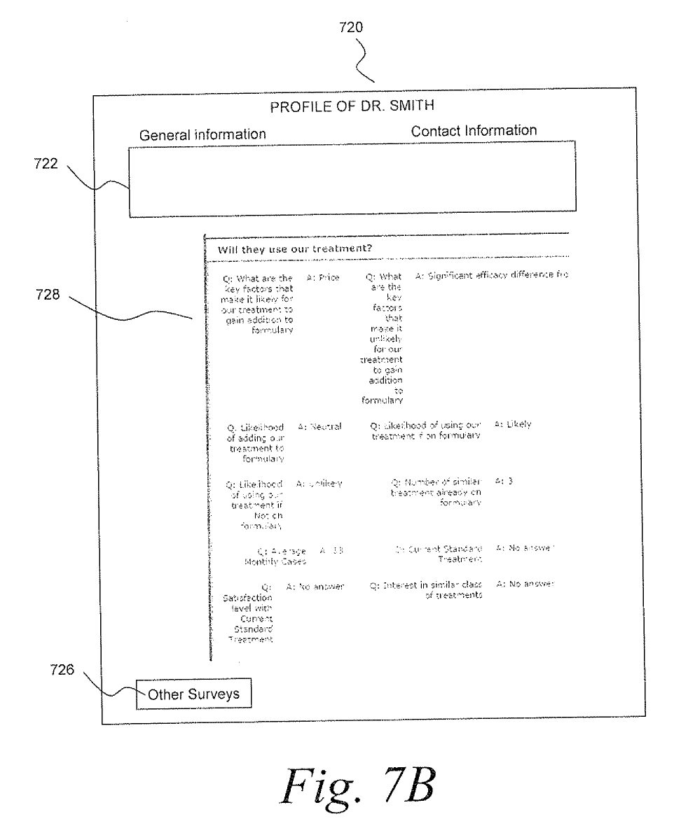

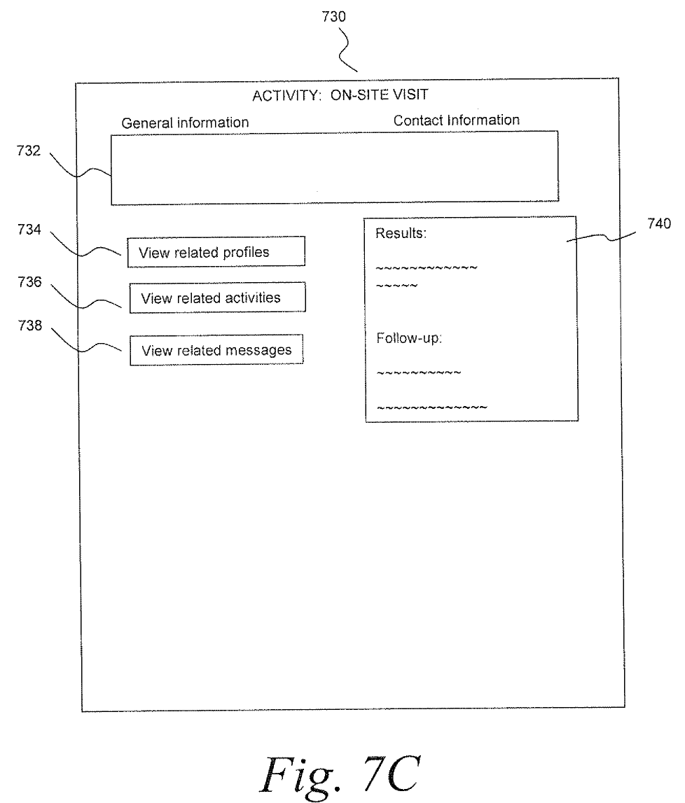

Referring now to FIGS. 7A, 7B, and 7C embodiments of example output screens are shown for the display of data corresponding to medical science liaisons. An output screen may be displayed on any display device of any of the computing devices 100 described herein. In some embodiments, an output screen may be displayed on a computer monitor. In another embodiment, an output screen may be displayed as an application. In one embodiment an output screen may be displayed inside a web browser. An output screen may comprise any display, scripting, or programming language including HTML, XML, SVG, Java, Javascript, and Flash.

The output screens may comprises any means of display, including text, images, animations, icons, menus, lists, tabs, spreadsheets, charts, graphs, plots, and diagrams. The output screens depicted may also comprise a number of input fields. Said fields may comprise any input fields described herein.

Referring now to FIG. 7A, a block diagram of an example of an output screen for display of message data relating to MSLs is shown. In brief overview, a message output screen 700 comprises a field for displaying messages 702, a field for specifying a category of messages to view 704, and fields for viewing messages corresponding to a given sender 706, activity 708, and profile 710.

Still referring to FIG. 7A, now in greater detail, an output screen 700 comprises a field 702 for displaying a number of messages. The field 702 may comprise any information corresponding to said messages, including message subjects, categories, dates, sender, recipient, priority, and whether or not a message has been read. In some embodiments, the field may comprise means for sorting the messages displayed therein, such as means for viewing a set of messages alphabetically by subject, or chronologically by date received.

An output screen 700 may comprise fields for specifying a category of messages to view 704. In one embodiment, said categories may correspond to a predetermined number of categories corresponding to activities of MSLs. For example, a field 704 may comprise a checkbox next to a category labeled “clinical questions.” Checking said checkbox may cause the message display field 702 to display all messages corresponding to clinical questions. An output screen 700 may also comprise a field for viewing a set of messages from a given sender 706.

An output screen 700 may also comprise a field for viewing a set of messages corresponding to a given activity 708. In one embodiment said field may provide functionality, such as a menu, allowing a user to select a given activity. The message display field 702 may then display the set of all messages corresponding to a given activity. In some embodiments, the messages displayed may comprise message which are linked to the given activity. In other embodiments, the messages displayed may comprise messages comprising text corresponding to a given activity.

An output screen 700 may also comprise a field for viewing a set of messages corresponding to a given profile 710. In one embodiment said field may provide functionality, such as a menu, allowing a user to select a given profile. The message display field 702 may then display the set of all messages corresponding to a given profile. In some embodiments, the messages displayed may comprise messages which are linked to the given profile. In other embodiments, the messages displayed may comprise messages comprising text corresponding to a given profile.

Referring now to FIG. 7B, a block diagram of an example of an output screen for display of profile data corresponding to medical professionals is shown. In brief overview, a profile output screen 720 comprises a field for displaying general information and contact information corresponding to a given medical professional 722, a field for displaying detailed information about the medical professional's interactions with an MSL 728, and a field for allowing a user to view more such detailed data 726.

Still referring to FIG. 7B, now in greater detail, a profile output screen 720 comprises a field for displaying general information and contact information corresponding to a given medical professional 722. Said field may display any information corresponding to a medical professional described herein. In some embodiments, the field 722 may comprise a number of sub-fields for display of particular categories of information.

A profile output screen 720 may also comprise a field for displaying detailed information about the medical professional's interactions with an MSL 728. In the embodiment shown, the field 728 displays detailed information about the possibility of the given medical professional using a given treatment. In other embodiments, said detailed information may comprise information corresponding to likelihood of adding a particular drug to a formulary, ability of a medical professional to influence others, the professionals current opinion of particular products, services, or industry trends. A profile output screen 720 may also comprise a field for displaying other such detailed information as described above 726.

Referring now to FIG. 7C a block diagram of an example of an output screen for display of activity data corresponding to medical science liaisons is shown. In brief overview, an activity output screen 730 comprises a field for displaying general information and contact information corresponding to a given activity 732, fields for viewing related profiles 734, related activities 736, and related messages 738, and a field for viewing results of the activity 740.

Still referring to FIG. 7C, now in greater detail, an activity output screen 730 comprises a field for displaying general information and contact information corresponding to a given activity 732. Said field 732 may display any information corresponding to an activity as described herein. In some embodiments, the field 732 may comprise sub-fields for the display of particular categories of information.

An activity output screen 730 may also comprise fields for viewing related profiles 734, related activities 736, and related messages 738. Said profiles, activities, and messages may be related in any manner described herein.

An activity output screen 730 may also comprise a field for the display of results corresponding to a given activity 740. Said field 732 may display any information corresponding to results of an activity as described herein. In some embodiments, the field 740 may comprise sub-fields for the display of a particular category of information.

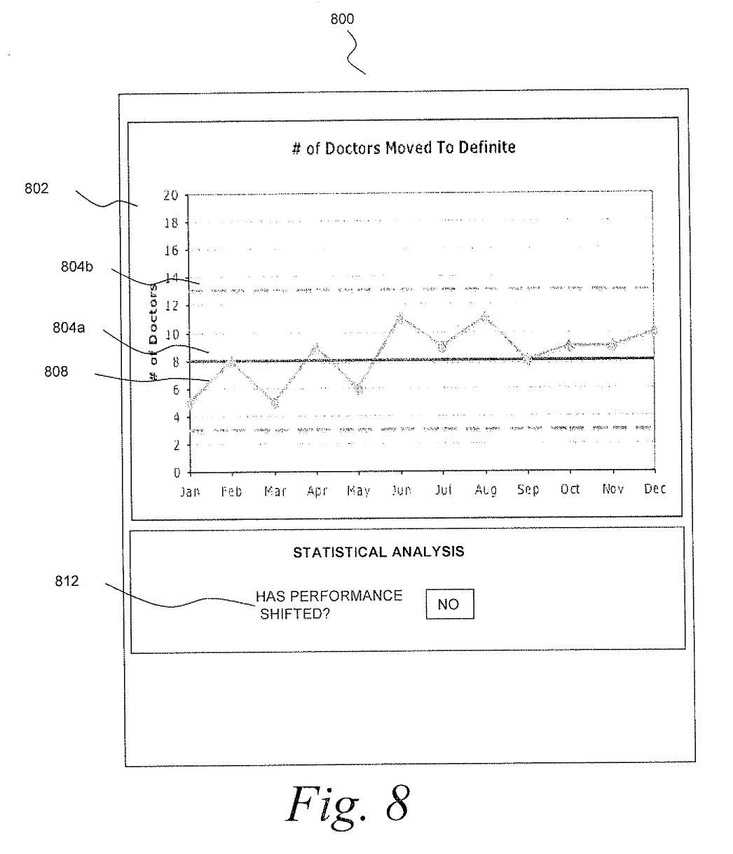

Referring now to FIG. 8, an example of an output screen for display of message data relating to MSLs is shown. In brief overview, an output screen 800 comprises a chart 802 displaying a data series 808 and displays corresponding to statistical measures 804a, 804b (collectively 804). An output screen 800 may also comprise a display 812 corresponding to the statistical significance of a change in said data series.

Still referring to FIG. 7, now in greater detail, an output screen 800 comprises a chart 802 displaying a data series. A chart 802 may comprise any elements typically used to display a data series, including titles, headers, axes, scales, legends, gridlines, plot lines, and borders. A chart 802 may comprise any type of chart used to display a data set, including a line graph, bar graph, xy plot, scatter plot, historical graph, pie chart, doughnut graph, radar graph, surface graph, area graph, and bubble graph.

A chart 802 may comprise a data series 808. Said data series may comprise data corresponding to any of the MSL messages, activities, and profiles described above. For example, in the embodiment shown, the data series corresponds to the number of doctors moved to ‘definite’ in an assessment of how likely given doctors are to adopt a treatment proposed by MSLs. In some embodiments, said data series may comprise a set of data corresponding to a given time interval. In another embodiment, said data series may comprise a set of data corresponding to a given set of medical liaisons. In yet another embodiment, said data series may comprise a set of proposed treatments.

A chart 802 may comprise displays corresponding to statistical measures 804. In one embodiment, the displays 804 may correspond to any mathematical property of a data set, including standard deviation, variance, mean, median, mode, maximum, minimum, and margin of error. For example, in the embodiment shown, the line 804a indicates the mean of the data series, and the line 804b indicates one standard deviation above the mean of the data series. In some embodiments, said displays 804 may correspond to statistical measures of a data set other than the data set displayed in the chart 802. For example, a line 804 may indicate the mean for a data set over a given year, while the chart 802 may only display a given month of the data set.

In other embodiments, the displays 804 may display a trend, projection, or target corresponding to a data series. For example, in the embodiment shown, a line might be displayed indicating that the target for each month was to move 10 doctors to “definite.” Or for example, a dashed line might be displayed indicating a likely trend for months in which data is not yet available.

An output screen 800 may also comprise a display 812 corresponding to a statistical analysis of the data series displayed in the chart 802. In some embodiments, said statistical analysis may comprise an analysis of whether said series of data is changing in statistically significant way. For example, in the embodiment shown, a display 812 indicates that the number of doctors moving to “definite” has not changed in a statistically significant way over the time period shown. Said display 812 may comprise any display element described herein, including text, images, and diagrams.

Referring now to FIG. 900, a block diagram of a second example output screen comprising a time-based visual depiction of data corresponding to the results of activities of MSLs is shown. In brief overview, an output screen 900 comprises a chart 802 comprising a data series 808. The output screen 900 also comprises a display of the statistical significance of a given property of the data set 812, and a business recommendation 914 based on said statistical analysis.

Still referring to FIG. 900, an output screen 900 comprises a chart 802. Said chart may comprise any chart described herein. In the embodiment shown, the chart 802 displays a bar graph corresponding to the numbers of doctors whose participation in a given treatment was moved to definite following a given event.

The output screen 900 also comprises a display 812 of the statistical significance of a property of the data series 808. In the embodiment shown, the display indicates that 85% of the doctors moving to definite were accounted for by two events. In other embodiments, the display 812 may display an indication corresponding to any other property of a data set 812, including trends, maxima, minima, proximity to target, variance, and margin of error.

The output screen 900 also comprises a display of a business recommendation 914 corresponding to said statistical analysis. In the embodiment shown, the business recommendation is to focus resources on driving the top two events, which are responsible for most of the doctors moved to definite. A business recommendation may comprise any recommendation for pursuing a given business plan, activity, strategy, or course. In one embodiment, a business recommendation may comprise hiring of personnel. In another embodiment, a business recommendation may comprise targeting specific doctors or hospitals. In still another embodiment a business recommendation may comprise maintaining a status quo. A business recommendation may comprise any of the display elements described herein, including text, images, and diagrams.

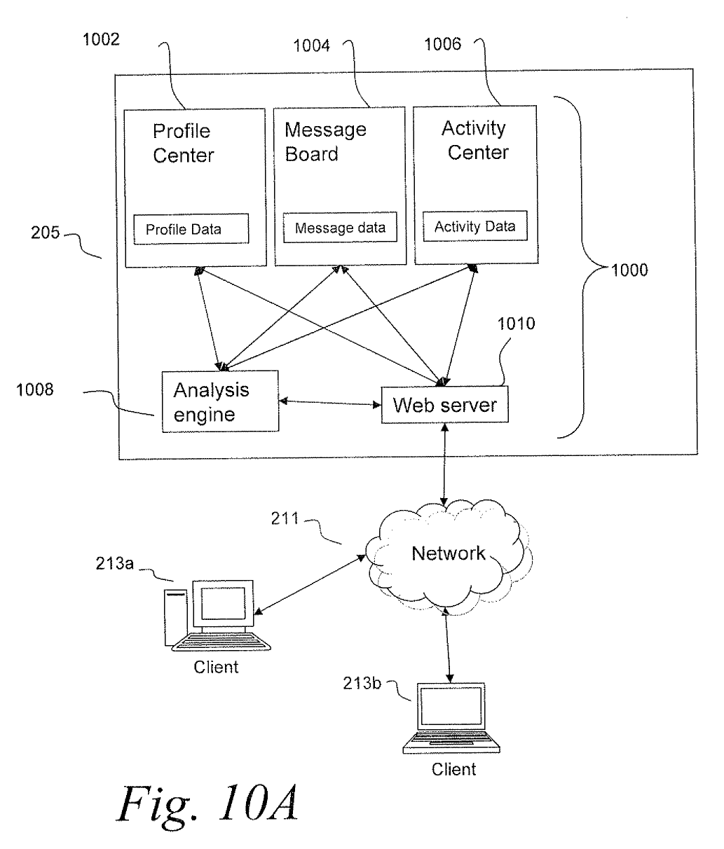

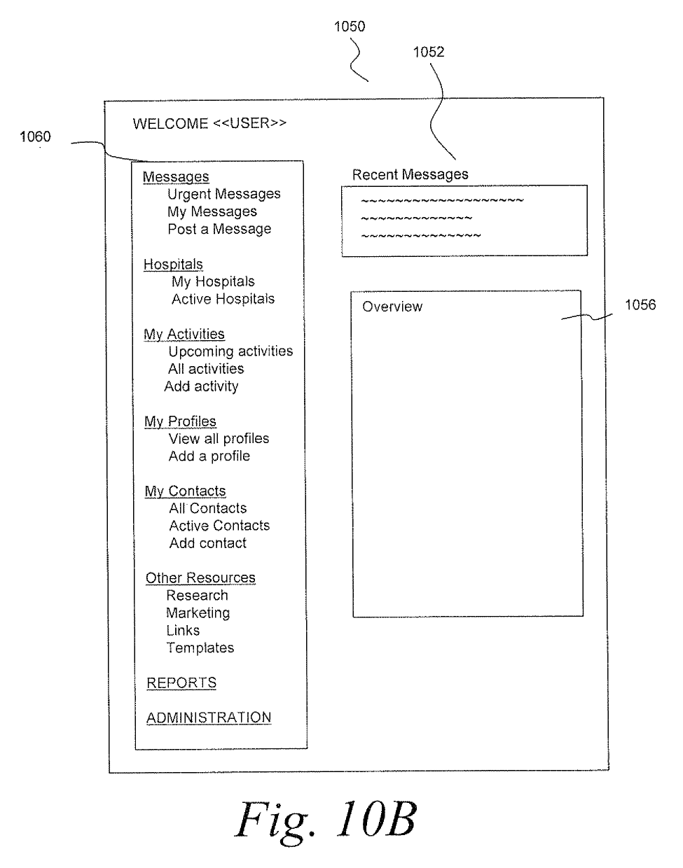

Referring now to FIG. 10A, a block diagram of an medical science liaison information center is shown. In brief overview, an MSL information center 1000 comprises a message board 1002 comprising message data, a profile center 1004 comprising profile data, an activity center 1006 comprising activity data, an analysis engine 1008, and a web server 1010. The MSL information center 1000 resides on a server 205 in communication with a plurality of clients 213 over a network 211.

Still referring to FIG. 10, now in greater detail, an MSL information center 1000 communicates with a plurality of clients 213 via a network 211. In some embodiments, the network 211 comprises the internet, and said communications occur via HTTP and HTML. In one embodiment, the MSL information center 1000 transmits a plurality of web pages corresponding to input and output screens as described herein for the collection and display of data relating to MSLs. In one embodiment, said web pages are displayed by the clients 213 using a web browser.

In the embodiment shown, the MSL information center resides 1000 on a server 205. In some embodiments, the MSL information center 1000 may reside on a plurality of servers. In one embodiment, the MSL information center 1000 may comprise one or more databases for storage of information. In another embodiment, the MSL information center 1000 may be implemented using a hosted services provider.

In one embodiment, a single MSL information center 1000 or any of the components of the MSL information center may provide separate functionality and data storage for multiple companies or organizations. In other embodiments, a plurality of MSL information centers 1000 may be used to service a plurality of organizations. For example, a pharmaceutical company may provide one MSL information center 1000 for its MSLs working in the area of cardiac drugs, and provide a logically or physically distinct MSL information center 1000 for its MSLs working in the area of diabetes drugs.

In some embodiments, a component 1002, 1004, 1006, 1008, 1010 of the MSL information center 100 may provide separate functionality and data storage for multiple companies or organizations. For example, the web server 1010 may customize the pages deployed to a given organization with company-specific formatting and logos. Or, for example, a single corporation may have a plurality of groups of MSLs. A message board 1004 may segregate the message of the MSLs by the product group with which the MSLs are associated, such that for example, an MSL working in the field of osteoporosis drugs could send a message that would be viewed by all other MSLs in that field, but would not be seen by MSLs working in the field of cancer treatments.

In the embodiment shown, the MSL information center 1000 communicates to a plurality of clients via a web server 1010. Said web server 1010 may comprise any web server or web servers capable of delivering content to clients 213. In one embodiment, the web server transmits a plurality of web pages corresponding to input and output screens as described herein for the collection and display of data relating to MSLs. The web server may incorporate information from the profile center 1002, message board 1004, activity center 1006, and analysis engine 1001 on any of the pages delivered to clients 213.

In the embodiment shown, a profile center 1002 stores and manages data relating to a plurality of profiles. In some embodiments, the profile center 1002 stores and manages data corresponding to profiles entered into the MSL information center 1000. Said profiles may correspond to any of the profiles described herein, and may be input or displayed according to any of the screens or methods described herein. In some embodiments, the profile center 1002 may utilize specialized hardware or software. In other embodiments, the profile center 1002 may share hardware or software with any other component of the MSL information center 1000.

In some embodiments, the profile center 1002 may comprise functionality for an administrator or manager to add surveys corresponding to some or all of the profiles existing in the system. For example, a company may desire to focus efforts on pediatric care, and add surveys with the profile of each doctor asking questions about the doctors involvement in pediatric care. In other embodiments, a profile center 1002 may comprise functionality for an administrator or manager to add, remove, or edit questions from existing surveys. In some embodiments, a profile center 1002 may provide means for an administrator or manager to set a deadline corresponding to a given survey. Said deadline may indicate to any relevant personnel that the survey needs to be completed by a given date. In some embodiments, the survey may be automatically removed or deactivated once the set deadline has passed. In other embodiments, results from the survey may be collected and stored upon occurrence of the deadline, but the survey may continue to remain active.

In some embodiments, the profile center 1002 may provide functionality for a given survey to be filled out by only one specific person. For example, if a survey corresponded to “doctor feedback” and comprised questions for a doctor relating to their satisfaction with the MSLs they were working with, the survey may be specifically published to the doctor. In one embodiment, the doctor would be given a unique username and password, and then would be able to log into an MSL information center 1000 to fill out the survey. The doctor may also be restricted from viewing any other portions of the MSL information center 1000. Or, for example, if a forecast survey was intended to be completed by sales personnel within a company, the survey might be published solely to the sales representatives responsible for the given forecast.

In some embodiments, if a manager wished to collect data from an individual MSL or group of MSLs, a survey may be published corresponding to the given MSLs. In one embodiment, the survey may then be displayed along with the given MSL or MSLs' profiles. For example, MSLs may be surveyed from time to time relating to compliance issues. An MSL could then complete the survey upon logging in to the MSL information center 1000. In some embodiments, surveys yet to be completed or links to surveys yet to be completed by a given MSL may be displayed in an MSL home page, as described in connection with FIG. 10B.

In the embodiment shown, an activity center 1006 stores and manages data relating to a plurality of activities. In some embodiments, the activity center 1006 stores and manages data corresponding to activities entered into the MSL information center 1000. Said activities may correspond to any of the activities described herein, and may be input or displayed according to any of the screens or methods described herein. In some embodiments, the activity center 1006 may utilize specialized hardware or software. In other embodiments, the activity center 1006 may share hardware or software with any other component of the MSL information center 1000.

In the embodiment shown, a message board 1004 stores and manages data relating to a plurality of messages. In some embodiments, the message board 1004 stores and manages data corresponding to messages entered into the MSL information center 1000. Said messages may correspond to any of the messages described herein, and may be input or displayed according to any of the screens or methods described herein. In some embodiments, the message board 1004 may utilize specialized hardware or software. The message board 1004 may comprise any functionality or elements common to existing message board systems, including means for input, storage, and viewing of messages. In other embodiments, the message board 1004 may share hardware or software with any other component of the MSL information center 1000.

In the embodiment shown, an analysis engine 1008 analyzes and processes data corresponding to the MSL information center 1000. In some embodiments, the analysis engine 1008 may comprise functionality for linking related elements, such as linking a profile to a related message, or a message to a related activity. In one embodiment, the analysis engine 1008 may perform the linking automatically by determining that two elements are related. For example, the analysis engine 1008 may determine that a user sent a message immediately after entering information corresponding to an activity, and subsequently link the message to the activity. Or, for example, the analysis engine 1008 may determine a set of messages relate to a given topic by keyword search, or analyzing the subject or category of the messages. In another embodiment, the analysis engine 1008 may link elements in response to user input indicating that two or more elements are related.

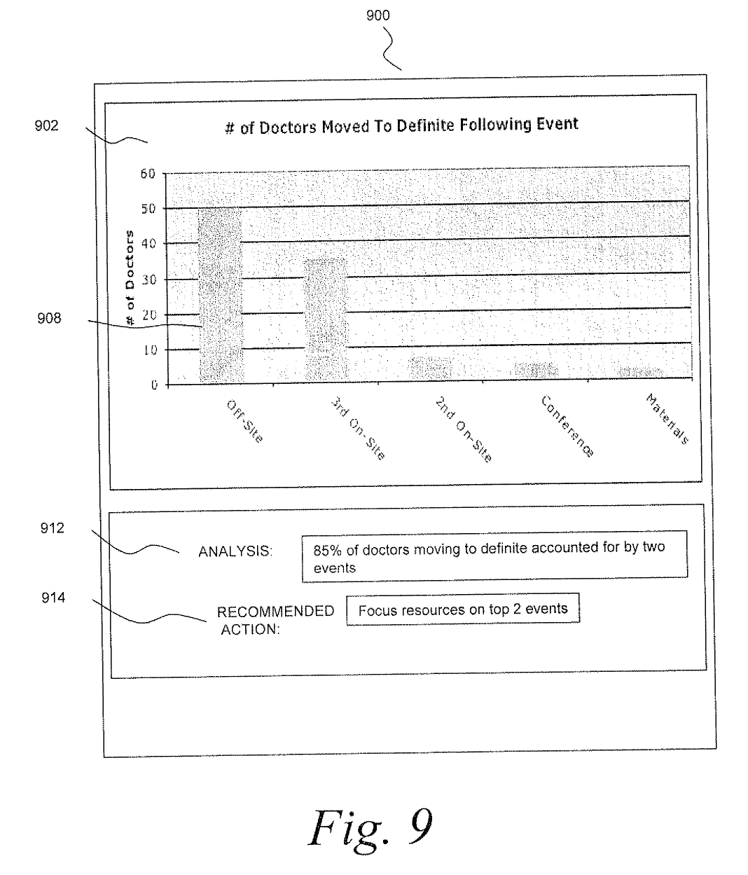

In other embodiments, the analysis engine 1008 may analyze data in the MSL information center for the purpose of providing statistical analyses or business recommendations. Said statistical analyses and business recommendations may comprise any of the statistical analysis methods described herein. For example, the analysis engine 1008 may provide outputs relating to statistical measures, such as standard deviation, for a given data set. Or, for example, the analysis engine 1008 may output a recommendation of expending more resources on distribution of research articles in response to a given data set. In one embodiment, the analysis engine 1008 may provide functionality for creating charts such as the charts in FIGS. 8 and 9.

For example, an analysis engine 1008 analyzing data to output a business recommendation might first check whether the given data is normal, in the statistical sense of normal. If the data is not normal, the analysis engine 1008 may automatically normalize the data, such as by using a Box-Cox transformation or any other specified normalization method. The analysis engine 1008 may then determine the standard deviation and mean of the normalized data set. The analysis engine 1008 may then look for patterns in the data potentially warranting inspection, such as points greater than three standard deviations from the mean, or a certain number of points greater than two standard deviations from the mean. The analysis engine 1008 may then generate an action corresponding to the pattern discovered. For example, an analysis engine 1008 might identify instances where 2 out of 3 consecutive data points on the same side of the mean for a data set fall 2 or more standard deviations from the mean. Or, for example, 8 consecutive points falling 2 or more standard deviations from the mean of the data set, or 9 or more consecutive points on the same side of the mean of the data set may be analyzed to generate a recommendation.

The analysis engine 1008 may also comprise functionality for storing data not directly included in the message board 1004, activity center 1006, and profile center 1002. In one embodiment, the analysis engine 1008 may store data relating to usage of the MSL information center 1000. In some embodiments, the analysis engine 1008 may store data corresponding to how often a given MSL accessed the MSL information center 1000. In other embodiments, the analysis engine may store data relating to the frequency and order in which given input screens or areas of the MSL information center 1000 are accessed.

In some embodiments, the analysis engine may be customized to generate specific charts or analyze a given set of data. For example, a given organization may wish to generate reports relating to the number of participating doctors in a geographical area as compared to the number of MSLs working in a given geographical area. The analysis engine could be customized to produce a chart similar to FIGS. 8 and 9 illustrating the correlation between MSL staffing and doctor participation across geographic regions. In some embodiments, the analysis engine may generate reports corresponding to usage of the MSL information center. For example, a report might be generated detailing the number of times the profile center has been accessed over a given time period. Or for example, a report might be generated tracking the time-to-response relating to questions or issues posted.

Referring now to FIG. 10B, a block diagram of an example home page for a user of an MSL information center 1000 is shown. In brief overview, the home page 1050 comprises a field for viewing recent messages 1052, a field for viewing a system overview 1056, and a navigation bar 1060.

Still referring to FIG. 10B, now in greater detail, the home page 1050 may be displayed on any computing device. In some embodiments, the home may be displayed on a client 213 communicating with an MSL information center 1000. In some embodiments the home page 1050 comprises an initial HTML page shown to users who directed a client 213 web browser to a given location. In some embodiments, a user may be required to log in or otherwise identify him or herself before the home page 1050 is displayed.

A home page 1050 may comprise a field for viewing recent messages 1052. Said field may display messages according to any of the embodiments described herein.

A home page 1050 may comprise a field 1056 for viewing an overview of the MSL information center 1000. In some embodiments, this field 1056 may display information corresponding to a total number of users of the MSL information center. In other embodiments, the field 1056 may comprise information corresponding to a total number of profiles, activities, or institutions entered into the MSL information center. In still other embodiments, the field 1056 may comprise information corresponding to instructions for the use of the MSL information center. In one embodiment, the field 1056 may comprise messages or statements from management corresponding to the MSL information center.

A home page 1050 may comprise a navigation bar 1060 for accessing any information and functionality of the MSL information center. In some embodiments, the navigation bar 1050 may comprise a series of HTML links to other web pages comprising other information and functionality of the MSL information center 1000. A navigation bar 1060 may comprise links to any of the input or output screens described herein.

In one embodiment, the navigation bar may comprise categories of functionality or information, each with a number of links within the category. For example, in the embodiment shown, a navigation bar 1060 may comprise a link 1061 for accessing a message board, along with links for specifically viewing urgent messages, a given user's messages, and posting a message. In some embodiments, a navigation bar 1060 may comprise links to any functionality and information described herein, including profiles, messages, activities, medical institutions, contacts, research and marketing materials, and reports and charts.

In some embodiments, a navigation bar 1060 may be displayed on any other input or output screen described herein. In some embodiments, a navigation bar 1060 may be customized for a given user or organization. In other embodiments, a navigation bar 1060 may be customized for a particular input or output screen.

In some embodiments, a navigation bar 1060 may comprise a link to administrative functions related to an MSL information center 1000. Examples of administrative functions may include setting up user accounts; assigning MSLs to managers, hospitals, and doctors; creating, editing, and collecting surveys; and coordinating any of the resources. In some embodiments, any or all of said administrative functions may be performed using a web interface.

In some embodiments, a home page 1050, any of the input or output screens described herein, or any other aspect of an MSL information center 1000 may be customized for viewing on a cellular telephone or personal digital assistant. For example, an MSL information center may comprise functionality for detecting whether a given user is logging in using a PDA, and deliver a home page customized for display on the particular PDA. Examples of customizations may include altering table layouts, changing navigation bars, altering text size, and limiting transmitted file sizes.

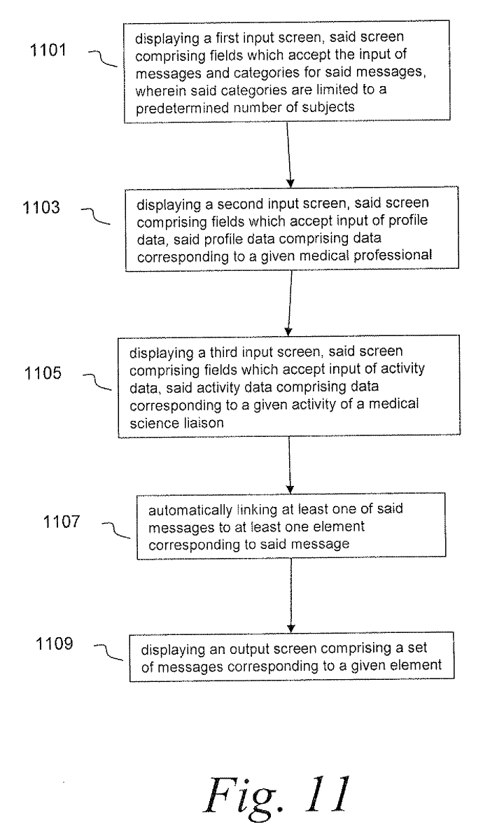

Referring now to FIG. 11, a flow diagram depicting one embodiment of a method for collection of data relating to MSLs is shown. In brief overview, the method comprises: displaying a first input screen, said screen comprising fields which accept the input of messages and categories for said messages, wherein said categories are limited to a predetermined number of subjects (Step 1101); displaying a second input screen, said screen comprising fields which accept input of profile data, said profile data comprising data corresponding to a given medical professional (step 1103); displaying a third input screen, said screen comprising fields which accept input of activity data, said activity data comprising data corresponding to a given activity of a MSL (step 1105); automatically linking at least one of said messages to at least on element corresponding to said message (step 1107); and displaying an output screen comprising a set of messages corresponding to a given element (step 1109). In one embodiment, the method depicted may be performed by any of the computing devices 100 described herein.

Still referring to FIG. 11, now in greater detail, a computing device 100 displays a first input screen comprising input fields which receive data corresponding to activities of MSL (step 1101). Said input screen may be displayed according to any of the embodiments described herein, and may accept input of data according to any of the embodiments described herein. In some embodiments, the input screen may displayed in response to a user directing a web browser to a given internet address. In one embodiment, a user may be required to log in or otherwise identify himself before the input screen is displayed. In another embodiment, the input screen may be displayed in response to a user opening an application.

A computing device 100 may then display a second input screen, said screen comprising fields which accept input of profile data, said profile data comprising data corresponding to a given medical professional (step 1103). Said input screen may be displayed according to any of the embodiments described herein, and may accept input of data according to any of the embodiments described herein. In the embodiment shown, said input screen is displayed after the message input screen is displayed (step 1101). In other embodiments, the profile input screen may be displayed (step 1103) before or during the display of the message input screen (step 1105).

A computing device 100 may then display a third input screen, said screen comprising fields which accept input of activity data, said activity data comprising data corresponding to a given activity of a medical science liaison (step 1105). Said input screen may be displayed according to any of the embodiments described herein, and may accept input of data according to any of the embodiments described herein. In the embodiment shown, said input screen is displayed after the message input screen is displayed (step 1101) and after the profile input screen is displayed (step 1103). In other embodiments, the activity input screen may be displayed (step 1105) either before or during the display of the message input screen (step 1101) and before or during the display of the profile input screen (step 1105).

In some embodiments, the input screens may all be displayed (steps 1101, 1103, 1105) on a single computing device 100. In other embodiments, the input screens may be displayed (steps 1101, 1103, 1105) on a plurality of computing devices 100. For example a given user may display the profile input screen (step 1103) on a computer at work to enter profile corresponding to a doctor the user was scheduled to meet, display the message input screen (step 1101) using a personal digital assistant to communicate while traveling, and display the activity input screen (step 1105) on a laptop used in a hotel to enter data relating to a conference attended.

A computing device 100 may then automatically link at least one of said messages to at least one element corresponding to said message (step 1107). An element may comprise a profile, activity, or another message. Said linking may be performed in accordance with any of the embodiments described herein.

In some embodiments, the computing device 100 performing said automatic linking (step 1107) may comprise the same computing device 100 displaying the input screens (steps 1101, 1103, 1105). For example, a personal computer may display a series of web pages corresponding to the message, activity, and profile input screens. As a user inputs data into said screens, the personal computer may determine that a given profile or activity corresponds to a given message by executing a script on a given web page. In other embodiments, the computing device 100 performing said automatic linking (step 1107) may comprise a different computing device 100 as the computing device 100 displaying the input screens (steps 1101, 1103, 1105). For example, the input screens may be displayed on personal computers, while the automatic linking is performed by an analysis engine 1008 on a server 205.

A computing device 100 may then display an output screen comprising a set of messages corresponding to a given element (step 1109). Said output screen may be displayed according to any of the embodiments described herein. In some embodiments, displaying a set of messages corresponding to a given element may comprise displaying a screen with a list of said set of messages. In other embodiments, displaying a set of messages corresponding to a given element may comprise displaying a set of messages, wherein the messages within said set which correspond to a particular element are specially indicated, such as by underlining, boldface, highlighting, or relative order in the set.

In some embodiments, the given element may be specified by a user. In some embodiments, a message display screen 700 may comprise functionality 708, 710 for viewing messages corresponding to a given activity or profile. In other embodiments, an activity or profile display screen may comprise a field for displaying related messages.

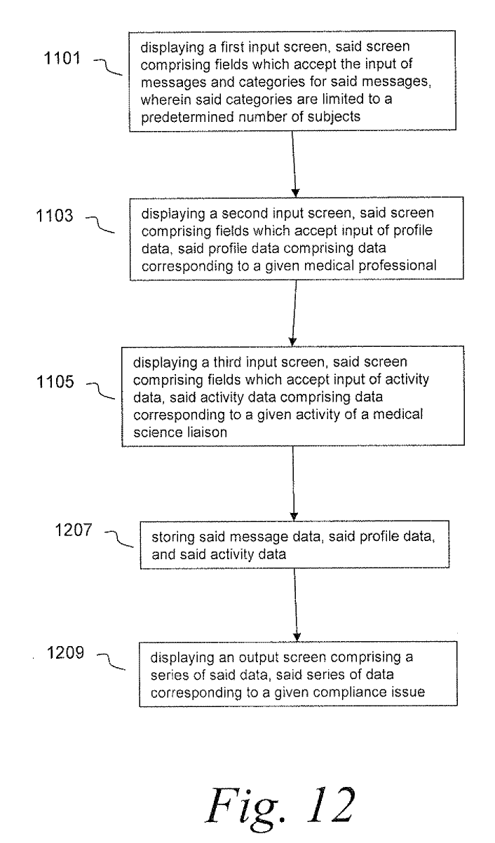

Referring now to FIG. 12, a flow diagram depicting one embodiment of a method for collection of data relating to compliance issues of medical science liaisons is shown. In brief overview, the method comprises: displaying a first input screen, said screen comprising fields which accept the input of messages and categories for said messages, wherein said categories are limited to a predetermined number of subjects relating to job functions of a medical science liaison (step 1101); displaying a second input screen, said screen comprising fields which accept input of profile data, said profile data comprising data corresponding to a given medical science liaison (step 1103); displaying a third input screen, said screen comprising fields which accept input of activity data, said activity data comprising data corresponding to a given activity of a medical science liaison (step 1105); storing said message data, said profile data, and said activity data (step 1207); and displaying an output screen comprising a series of said data, said series of data corresponding to a given compliance issue (step 1209).

Still referring to FIG. 12, now in greater detail, a computing device 100 displays a first input screen, said screen comprising fields which accept the input of messages and categories for said messages, wherein said categories are limited to a predetermined number of subjects relating to job functions of a medical science liaison (step 1101). This step may be performed in accordance with any of the embodiments described herein.

A computing device 100 may then display a second input screen, said screen comprising field said screen comprising fields which accept input of profile data, said profile data comprising data corresponding to a given medical science liaison (step 1103). This step may be performed in accordance with any of the embodiments described herein.

A computing device 100 may then display a third input screen, said screen comprising fields which accept input of activity data, said activity data comprising data corresponding to a given activity of a medical science liaison (step 1105). This step may be performed in accordance with any of the embodiments described herein.

In some embodiments, the input screens may all be displayed (steps 1101, 1103, 1105) on a single computing device 100. In other embodiments, the input screens may be displayed (steps 1101, 1103, 1105) on a plurality of computing devices 100. The input screens may be displayed (steps 1101, 1103, 1105) in any order, including simultaneously.

A computing device 100 may then store said message data, said profile data, and said activity data (step 1207). In some embodiments, the data may be stored using an MSL information center 1000. In other embodiments, the data may be stored on any other computing device, storage element, or combination of computing devices and storage elements. In some embodiments, the data may be stored in a structured environment, such as a database, to permit faster retrieval. Said data may be stored in any format, including text, XML, HTML, and binary formats.

A computing device 100 may then display an output screen comprising a series of said data, said series of data corresponding to a given compliance issue (step 1209). In some embodiments, the series of data may comprise a series of messages. In other embodiments, the series of data may comprise a series of profiles. In still other embodiments, the series of data may comprise a series of activity data. Said series of data may be displayed (step 1209) in any manner discussed herein.

In some embodiments, said series of data may comprise a series of data over a given time period. In other embodiments, said series of data may comprise a series of data over a given geographical region. In still other embodiments, said series of data may comprise a series of data corresponding to a particular MSL or group of MSLs. In other embodiments, said series of data may correspond to a particular product or product trial. In still other embodiments, said series of data may correspond to a particular medical institution.

A compliance issue may comprise any issue relating to governmental laws, regulations, and guidelines concerning MSLs and the health and medical industries. Compliance issues include compliance with Food & Drug Administration regulations and guidelines, and guidelines promulgated by the Department of Health and Human Services. In some circumstances, compliance issues may involve regulations concerning permissible activities for MSLs in relation to doctors. In other circumstances, compliance issue may involve regulations concerning statements made about a given product or treatment.

In some embodiments, said series of data may correspond to a series of management actions. For example, in regards to a compliance issue relating to claims made about a particular treatment, a series of data may correspond to management messages to MSLs describing proper procedure for discussing the treatment with doctors. Or, for example, said series of data may comprise a set of messages sent by management advising MSLs of a current investigation, complaint, or regulatory inquiry.

In some embodiments, a series of data may comprise a series of responses to management actions. For example, in regards to a compliance issue relating to claims made about a particular treatment, a series of data may correspond to MSL messages to management describing their procedure for discussing the treatment with doctors.

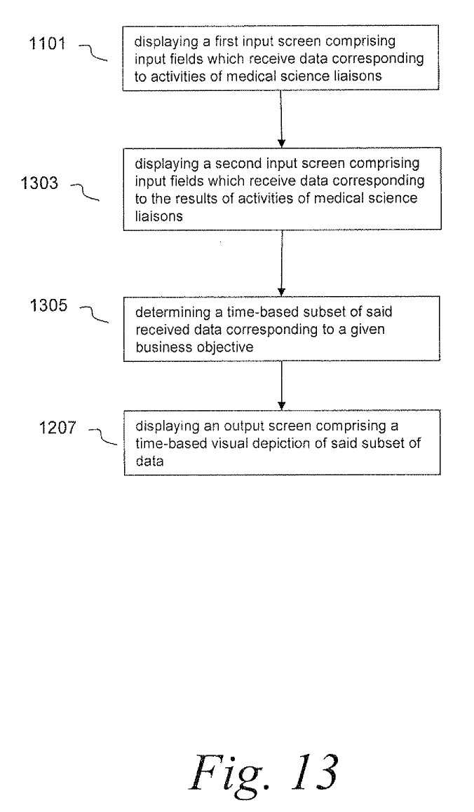

Referring now to FIG. 13, a flow diagram depicting one embodiment of a method for collection and analysis of data relating to medical science liaisons is shown. In brief overview, the method comprises displaying a first input screen comprising input fields which receive data corresponding to activities of medical science liaisons (step 1101); displaying a second input screen comprising input fields which receive data corresponding to the results of activities of medical science liaisons (step 1303); determining a time-based subset of said received data corresponding to a given business objective (step 1305); and displaying an output screen comprising a time-based visual depiction of said subset of data (step 1307).

Still referring to FIG. 13, now in greater detail, a computing device 100 may display a first input screen comprising input fields which receive data corresponding to activities of medical science liaisons (step 1101). This step may be performed in accordance with any of the embodiments described herein.

A computing device 100 may then display a second input screen comprising input fields which receive data corresponding to the results of activities of medical science liaisons (step 1303). This step may be performed in accordance with any of the embodiments described herein.

A computing device 100 may then determine a time-based subset of said received data corresponding to a given business objective (step 1305). A business objective may comprise any objective relating to MSLs and their job performance. Examples of business objectives include increasing doctor contacts, increasing the number of affiliated hospitals, increasing the number and size of clinical studies relating to a product, increasing the awareness of a particular treatment, and making research available.

In some embodiments, the business objective may be entered by a user of an MSL information center 1000. In other embodiments, business objectives may be preprogrammed into an MSL information center 1000 or an analysis engine 1008. In some embodiments, a user may specify a specific time interval for the data. In other embodiments, a relevant time interval may be automatically identified by an analysis engine 1008.

In some embodiments, said subset of data may comprise a series of data over a given geographical region. In other embodiments, said subset of data may comprise a series of data corresponding to a particular MSL or group of MSLs. In other embodiments, said subset of data may correspond to a particular product or product trial. In still other embodiments, said subset of data may correspond to a particular medical institution.

In some embodiments, a time based subset of data may comprise a subset of data from a given time period. For example, a subset of data may comprise the number of doctors administering a given treatment in a number of successive months. Or, for example, a subset of data may comprise the number of activities corresponding to a given medical institution over a number of successive weeks.

In other embodiments, a time-based subset of data may comprise a set of actions and subsequent results. In one embodiment, a subset of data may comprise a number of activities of a given type, along with potential results of said activities. For example, a subset of data may comprise a number of conferences attended and the resulting number of new contacts obtained at said conferences. Or for example, a subset of data may comprise a number of different types of doctor interactions, along with the results of said interactions.

In some embodiments, a computing device 100 may determine that a particular activity type is correlated with a given result. For example, it may be determined that lunch meetings with doctors have a high correlation to increased likelihood of doctor participation, as compared to email contacts. Said determination may be made using any statistical technique known or described herein.

In some embodiments, an MSL information center 1000 may determine the time based subset of said received data corresponding to a given business objective. In other embodiments, an analysis engine 1008 may determine the time-based subset of said received data corresponding to a given business objective.

A computing device 100 may then display an output screen comprising a time-based visual depiction of said subset of data (step 1307). This step may be performed in accordance with any of the embodiments described herein. In some embodiments, the display may also comprise a visual depiction of the statistical significance of said data, as described herein. In other embodiments, the display may also comprise a business recommendation relating to said subset of data, as described herein.

We claim:

1. A method for collection of data relating to compliance issues of medical science liaisons, said method comprising:
(a) displaying a first input screen, said screen comprising fields which accept the input of messages and categories for said messages, wherein said categories are limited to a predetermined number of subjects relating to job functions of a medical science liaison;
(b) displaying a second input screen, said screen comprising fields which accept input of profile data, said profile data comprising data corresponding to a given medical science liaison;
(c) displaying a third input screen, said screen comprising fields which accept input of activity data, said activity data comprising data corresponding to a given activity of a medical science liaison;
(d) storing said message data, said profile data, and said activity data; and
(e) displaying an output screen comprising a series of said data, said series of data corresponding to a given compliance issue.

2. The method of claim 1, wherein step (e) comprises displaying an output screen comprising a series of said message data corresponding to a given compliance issue.

3. The method of claim 1, wherein step (e) comprises displaying an output screen comprising a series of said activity data corresponding to a given compliance issue.

4. The method of claim 3, wherein said series comprises a series of activity data corresponding to a given time period and corresponding to a given compliance issue.

5. The method of claim 3, wherein said series comprises a series of activity data corresponding to a given doctor.

6. The method of claim 3, wherein said series comprises a series of activity data corresponding to a given hospital.

7. The method of claim 1, wherein step (e) comprises displaying an output screen comprising a series of said data, said series of data comprising data corresponding to a given Food & Drug Administration rule.

8. The method of claim 1, wherein step (e) comprises displaying an output screen comprising a series of said data, said series of data comprising data corresponding to a given Department of Health and Human Services compliance program.

9. The method of claim 1, wherein step (e) comprises displaying an output screen comprising a series of data corresponding to management actions, said management actions corresponding to a given compliance issue.

10. A computer system for collection of data relating to compliance issues of medical science liaisons, said computer system comprising:
a first input screen comprising fields which accept the input of messages and categories for said messages, wherein said categories are limited to a predetermined number of subjects relating to job functions of a medical science liaison;
a second input screen comprising fields which accept input of profile data, said profile data comprising data corresponding to a given medical science liaison or other medical professional;
a third input screen comprising fields which accept input of activity data, said activity data comprising data corresponding to a given activity of a medical science liaison;
a storage element storing said message data, profile data, and activity data; and
a display screen comprising a series of said messages, said series comprising a number of messages corresponding to a given category.

11. The system of claim 10 wherein said output screen comprises a series of said message data corresponding to a given compliance issue.

12. The system of claim 10 wherein said output screen comprises a series of said activity data corresponding to a given compliance issue.

13. The system of claim 10, wherein said output screen comprises a series of activity data within a given time period and corresponding to a given compliance issue.

14. The system of claim 10, wherein said output screen comprises a series of activity data corresponding to a given doctor and corresponding to a given compliance issue.

15. The system of claim 10, wherein said series comprises a series of activity data corresponding to a given hospital and corresponding to a given compliance issue.

16. The system of claim 10, wherein said output screen comprises a series of said data, said series of data comprising data corresponding to a given Food & Drug Administration rule.

17. The system of claim 10, wherein said output screen comprises a series of said data, said series of data comprising data corresponding to a given Department of Health and Human Services compliance program.

18. The system of claim 10, wherein said output screen comprises a series of said data corresponding to management actions, said management actions corresponding to a given compliance issue.
